(19) United States
(12) Patent Application Publication
(10) Pub. No.: US 2018/0260556 A1
(43) Pub. Date: Sep. 13, 2018

(54) SECURE DATA AND PASSWORD STORAGE AND RECALL SYSTEM

(71) Applicant: Meir Avganim, Gealya (IL)

(72) Inventor: Meir Avganim, Gealya (IL)

(21) Appl. No.: 15/915,813

(22) Filed: Mar. 8, 2018

Related U.S. Application Data
(60) Provisional application No. 62/469,180, filed on Mar. 9, 2017.

(51) Int. Cl. G06F 21/40; G06F 21/45; G06F 21/78; G06F 21/32; G06F 21/62

(52) U.S. Cl. CPC G06F 21/40; G06F 21/45; G06F 21/6209; G06F 21/32; G06F 21/78

(57) ABSTRACT

A method for securely storing data content, including passwords, and recalling any of the data and the stored passwords in a computer using a highly secured approach. Primarily, the present invention provides a dedicated memory area region that is impenetrable to hacking, not via the internet and not via any implanted Trojan software. Dedicated storage space is provided which is inaccessible to all, except via a keyboard communicating directly with the user's computer.

### CROSS-REFERENCE TO RELATED APPLICATION

The present patent application is a nonprovisional and claims the benefit of and priority to U.S. Provisional Patent Application No. 62/469,180, filed on Mar. 9, 2017, by Meir Avganim, and entitled “SECURE DATA AND PASSWORD STORAGE AND RECALL SYSTEM,” the entire content of which is hereby incorporated by reference herein.

### BACKGROUND OF THE INVENTION

The present invention relates generally to information systems and, more particularly, to a uniquely configured system and method for managing access to confidential data and passwords stored in a computer, to restrict access to that information. Advantageously, the present invention provides a method for creating, storing, accessing, retrieving and displaying a plurality of records wherein the records may include confidential data, account identification, user IDs, passwords and the like. In a prior application Ser. No. 14/937,186, the instant inventor describes a system directed to user IDs and passwords that are accessible by use of a single master passcode. The present Specification repeats and amplifies upon the contents of said prior application.

User IDs and passwords are commonly used tools for protecting access to restricted data. Such data may include the personal information of an individual such as financial account information or medical history information. As is well known, such information is typically stored in various systems such as on websites and in various computer systems. Passwords provide a common means for user authentication prior to allowing access to systems and accounts in order to prevent misuse of such information. More broadly, all information stored in computers requires protection against intrusion, e.g., copying or alteration, by unauthorized operators, via the Internet or even through the locally provided data entry means such as the keyboard, touch pad, touch screen, mouse, WiFi devices and the like.

For example, identity theft is a growing problem and is due in large part to the ever increasing amounts of information that are now stored in various internet-accessible accounts. Common forms of identity theft include the unauthorized access and misuse of credit card information in order to obtain goods and services by someone impersonating the account holder. Passwords are commonly used to guard against unauthorized access to information. Such information can include website names and/or addresses and associated account information, bank account numbers, credit card information such as credit card numbers, three and four digit security codes for credit cards, stock brokerage account numbers, insurance policy numbers.

Other information that may be subject to unauthorized access may include computer or application names and associated files and information, passport and drivers license numbers, alarm codes, membership program information such as airline frequent flyer program account numbers, hotel and car rental loyalty numbers, bank PIN codes, and web domain and hosting account access information. It is also sometimes desirable to have quick and easy access to certain types of information such as alarm company telephone numbers, expiration dates for driver's license and passport numbers as well as customer service telephone numbers.

As the majority of sensitive information is increasingly stored in computer systems, many individuals have multiple accounts requiring user IDs and passwords which correspond to each account. Ideally, a different password is used with a different account in order to help avoid the above-mentioned problem of unauthorized access to the account should an unauthorized person discover the particular user ID and password for a single account. The large number of user IDs and corresponding passwords increases complexity and presents problems associated with convenience and security of the accounts.

As a result, many users develop a tendency to use simple passwords or even the same password for different accounts. In this manner, instead of memorizing a plurality of different passwords corresponding to different user IDs, it is only necessary to memorize a single or a few passwords. Unfortunately, the practice of utilizing an easy-to-guess password or the same password for different accounts may compromise the security of any one of the accounts should an unauthorized person discover the identity of a password.

In an attempt to avoid the security risks with using the same password for different accounts, some users may use different passwords for different accounts but may generate hand written notes, sometimes on a single piece of paper, listing each user ID and password associated with an account. Unfortunately, such practices pose a risk that the paper may become lost or misplaced and/or found by and/or stolen by someone who may misuse the information. Alternatively, some users generate a computer record of accounts, user IDs and/or passwords and may attempt to hide the information by storing it in a hidden or misdescriptive folder or file. This poses a risk that someone with unauthorized access to the computer, such as a hacker, may easily get at such information through the use of increasingly sophisticated prying and password-guessing technology.

Complicating the problem, some online accounts require that users change their passwords on a periodic basis such as on a monthly basis which forces the user to come up with even more passwords if they want to use unique passwords for all their accounts, thus exacerbating the problem of managing and remembering all those passwords. For diligent individuals, the use of hard-to-guess passwords often results in the user being unable to recall the complex password and then wasting time trying to remember or try passwords, or requiring that the user request a password reminder or reset during which time the user may be unable to access their accounts.

As can be seen, there exists a need in the art for a system and method for storing multiple records of different passwords for different accounts. More particularly, there exists a need in the art for a system and method for storing a plurality of confidential records such as an account identification along with corresponding login or authentication information such as a user ID and password. In addition, there exists a need in the art for a system and method for storing a plurality of confidential records, any type of confidential record, wherein the records are conveniently stored and accessible in a single location and which allows for the use of hard-to-guess or complex passwords thereby minimizing the risk that information may be accessed by an unauthorized user.

Although certain systems and algorithms have been disclosed to ameliorate and solve the aforementioned difficulties and requirements as described, for example, in the United States patent publication 2009/0328198, it remains so that existing solutions remain vulnerable to hackers installing on users' computers, tablets, and/or telephones, Trojan horse programs that snoop and report to the hackers confidential information as it is being entered into the database or recalled therefrom.

The contents of the aforementioned U.S. Patent Publication No. 2009/0328198 and the contents of U.S. Patent Publication No. 2008/0147967 are incorporated by reference herein.

Of particular significance for the present invention, is the requirement to be able to provide storage within a computer system that is simply inaccessible to any external source, be it through the internet or another computer or another system. The objective is to provide a virtual moat around special contents within a computer system that would be available only to a user of the particular computer, and only via access to the information directly through the use of the local keyboard or other inputting device of the computer, e.g., mouse, touch pad and the like, which is not available in the prior art. This need also includes the objective to disable use of the local computer inputting devices by all except for the person authorized to use each specific computer.

### SUMMARY OF THE INVENTION

It is an object of the present invention to provide a system that avoids the drawbacks of the prior art.

In addition to the objectives of the invention that relate to passwords, it is a further object of the invention to provide an impenetrable memory storage within a computer system that cannot be hacked, or copied or altered or accessed except from the keyboard or other inputting device by a human sitting and operating those devices.

It is another object of the invention to provide a system that insulates the system of creating, storing and recalling passwords and other confidential content from snooping by disconnecting the computer or tablet or mobile telephone from the Internet and/or from any external devices during utilization of the software used for creating, storing and recalling passwords and similar confidential information.

The foregoing and other objects of the invention are realized in the system according to the invention which preferably comprises a system for securely storing and recalling confidential contents in computer data records, protected from being hacked via the Internet and Trojan software, the system comprising: a computer including confidential data handling software configured to enable a user to store in and retrieve from said computer said confidential contents solely via a local user inputting device; communication hardware and software configured to enable the computer to communicate with other computers over public communication lines; a software facility for turning off said communication hardware while the user is engaged in active utilization of said confidential data handling software; and a software facility for blocking attempts to access said confidential contents by means that do not use said local user inputting device. Preferably, the confidential data handling software is configured to store biometric information of at least one authorized user and the system includes authenticating software for authenticating a user based on said stored biometric information associated with the user.

Preferably, the system includes software for authenticating the software handling software to the user by displaying or playing to the user at least one of alpha-numeric information, visual information and/or vocal information recognizable by the user. The confidential contents are stored only in pre-defined, locally provided memory locations of said computer. Also, a facility for encrypting said confidential content inputted into said computer is provided. Preferably, the system includes a software facility configured to store and display said confidential content based on personal encryption rules selected by and entered into the computer by the user. Preferably, the system includes authenticating software configured to authenticate a user by requiring the user to enter a password that is unique to that user, said authenticating software being configured and serving only for the purpose of initiating operation of the confidential content handling software. Preferably, the system includes a facility that enables retrieving one or more passwords by inputting into the computer a single, master password.

Preferably, the memory locations are located at a fixed, non-virtual range of memory addresses within said computer and the local user inputting device comprises a special keyboard connected to a computer with an external connector and said keyboard is used exclusively in conjunction with said password handling software. Preferably, the confidential data handling software is configured to prevent storage in a keyboard buffer of said computer any keystrokes other than keystrokes that are entered by a human manually.

The system also comprises the methods to achieve the above described functionalities.

Other features and advantages of the present invention will become apparent from the following description of the invention which refers to the accompanying drawings.

### BRIEF DESCRIPTION OF THE DRAWINGS

FIG. 1 is a prior art, conventional block diagram of a computer system, having an architecture usable with the present invention.

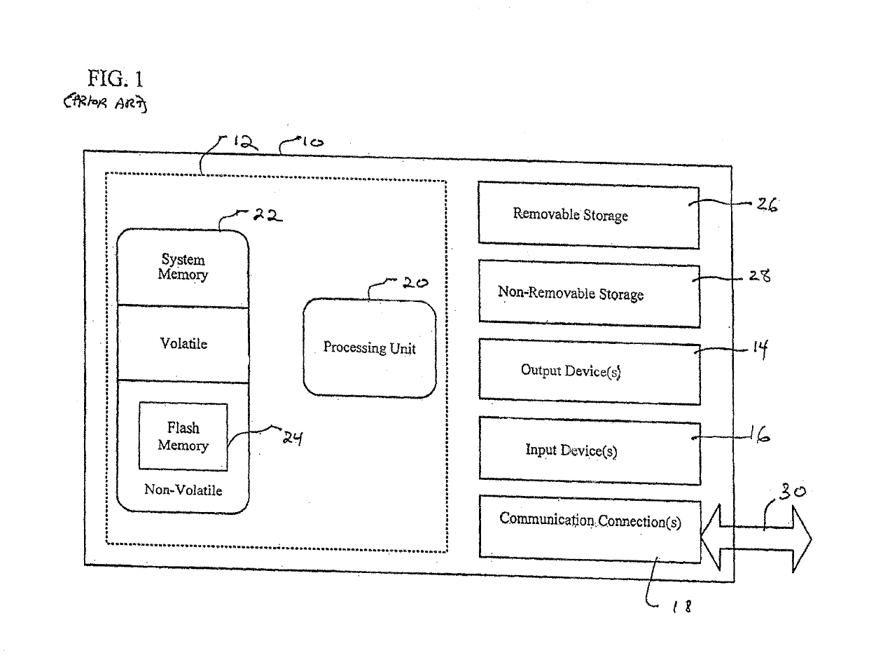

FIG. 2 is a flowchart of a setup program in accordance with the present invention.

FIG. 3 is a program usage protocol flowchart in accordance with the present invention.

FIG. 4 is a password programming module in accordance with the present invention.

FIG. 5 is a hardware block diagram of the system of the present invention in accordance with a second embodiment thereof.

FIG. 6 is a software block diagram of the system which is usable with the second embodiment of the present invention.

### DETAILED DESCRIPTION OF EMBODIMENTS OF THE INVENTION

Referring to the drawings, and with reference to a first embodiment of the invention, the overall computer, tablet, mobile telephone or any other communication device (not shown) in accordance with the present invention is internally provided with a controller/processor and communication hardware 10, which includes a processor 12, removable storage 26, non-removable storage 28, and output devices 14, comprising, for example, a printer, a display, a speaker system and the like. The accessories/peripherals may also include input devices 16 which may comprise a keyboard, a camera, a microphone and the like. Lastly, the peripherals also include communication connection hardware 18, communicating over a bus 30 and providing access through communication hardware channels 30 which may comprise landline telephone lines and wireless communications, through which one may communicate to other devices through the Internet or internal communication paths and the like, all as well known in the art.

Within the processor 12, the central unit for executing all of the algorithms is the processing unit 20 which operates with its own internal memory 22, which may include system memory, volatile memory, flash memory 24 and other non-volatile memory, such as RAM and the like. As is well known to all skilled in the art, software modules enable the processing unit 20 to execute various specific algorithms defined further on, to obtain specific functionality and to provide the unique physical outputs that are described and elaborated further on, in order to achieve the solutions provided by the present invention.

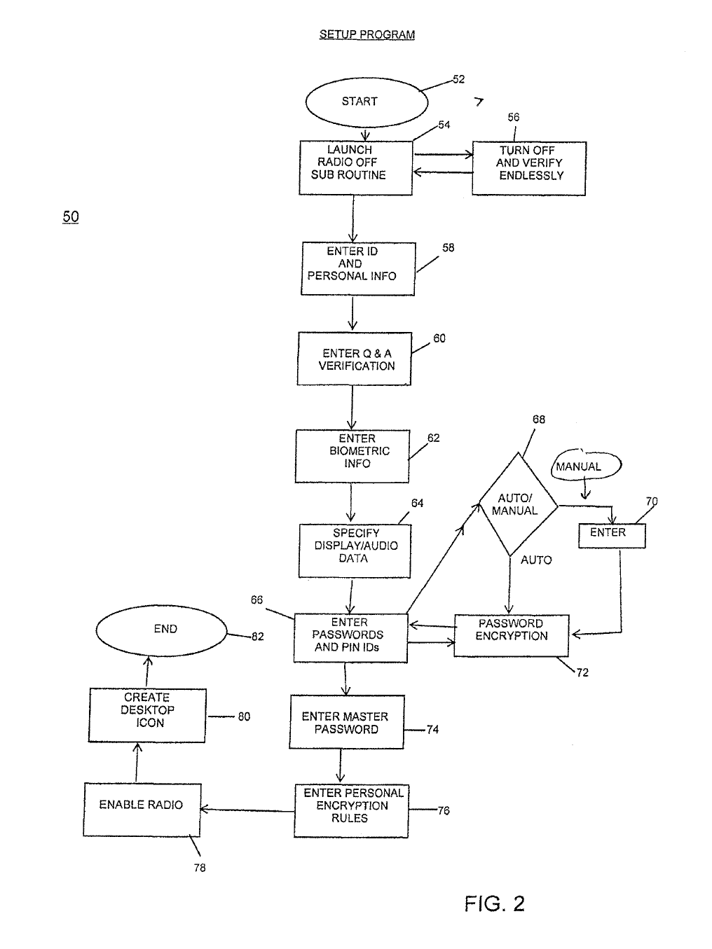

Referring to FIG. 2, the setup program 50 comprises several software modules stored within the memory of the processor 12 (or optionally external thereto) which executes an algorithm which commences with a start box 52 and launches itself either upon being loaded by operator commands or by pressing of an icon. The algorithm starts by turning off the radio or landline communications hardware 18/30 at box 54, to avoid any external snooping or listening or eavesdropping on the setup program 50. To this end, at the box 56 is executed a continuous subroutine which keeps instructing the communication hardware 18 to turn off. The software continually verifies that this has been done, to avoid an external device or Trojan horse software that has been embedded within the computing device from turning on the radio communication.

Thereafter, the user is prompted to enter his/her personal identification information at 58, to provide all kinds of information intended to be used for authentication and verification purposes as explained below. In the same vein, question and answer verification is entered in box 60, this information comprises posing to the user questions and to choose and provide answers to these favorite questions, for example, the year the user graduated from high school; the place of their birth; and the like. At module 62, the user is prompted to enter biometric information, and this can comprise allowing the processor's camera (not shown) to take a photo of the user and/or a fingerprint, or to store a voice sample of the user.

At box 64, the user specifies whether the password information will be provided through the display of the processor or possibly through a speaker.

Continuing with the program setup, box 66 requests the user to enter the names of institutions for which passwords are to be stored, as well as the corresponding passwords. This process can involve either an automatic software that chooses the password, or a manual data entry. Thus, at decisional box 68, the user is asked to indicate whether the preference is to automatically generate the passwords. If yes, the process proceeds to software module 72, where the passwords are generated, and then stored in encrypted form. If the password selection is to be manual, the process continues to software module 70, where the information is manually entered and thereafter encrypted at software module 72.

Once all of the passwords have been entered and the information recorded and encrypted, the program proceeds to software module 74 where the user is asked to input his preferred master password. If should be noted that this master password might be limited to the selection of a combination of both letter characters and numerics and be of a minimum size, e.g., more than six characters.

In addition, the user can provide at software module 76 her/his personal encryption rules for both the entry of data via the setup software, as well as during the software display of the passwords. For example, a user may specify that when passwords are displayed, the third letter character in the password is always to be a character which is two letters higher in the alphabet. Similarly, for numerics, the user can specify that the second numeric character is really the number that is obtained by either adding or subtracting “4” to that numeric. Thus, when a user enters the password “ABC123”, the software might actually interpret that as standing for the master password “ABE127”. As a result, even if snooping software would report the keyboard strokes to a remote hacker location, the hacker would still be in the dark as to the actual characters that comprise the master password, because they would not be privy to the personal encryption rule that the user had created during the initial program setup.

Once the software has been set up, the radio communication is re enabled at software module 78, and simultaneously the desktop icon is created at 80, which enables the user subsequently clicking on that desktop icon whenever the user wants information about any particular password that he/she may need in order to enter it for communicating with a given institution which may a bank, a retail store, and the like. The program ends at 82.

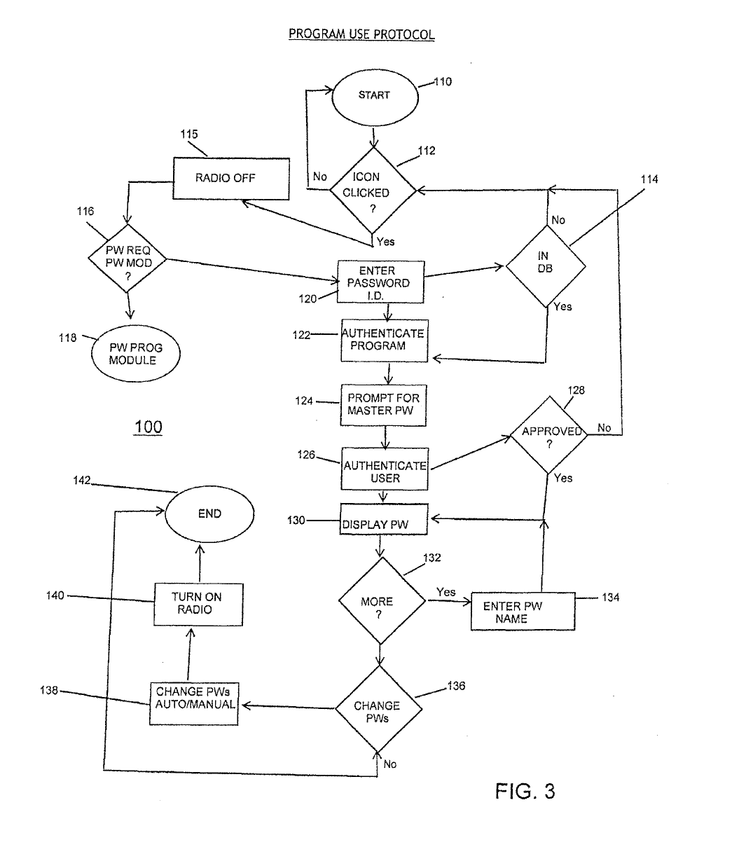

Reference is now made to FIG. 3, for a description of the use of the computer program, system and facility of the present invention. The use program 100 is launched at module 110 and proceeds to decisional box 112 to determine whether a user has clicked the user icon. If no, the program waits for such a click to occur. If yes, the program first turns off communications with the world outside the given computer and then proceeds to software module 116. Here the decision software queries whether the applicant wishes to modify/alter any particular password. If the user desires to modify a password, the program proceeds to software module 118 which redirects the program to the password programming modules previously described with reference to FIG. 2.

Otherwise, the program proceeds to software module 120, which requests and displays information to prompt the user to identify the institution or facility for which a password is requested, e.g., Chase Bank or Amazon or Ebay or the like. In decisional box 114 the program determines whether the requested password is in the database. If not, the program ignores the request, issuing a display such as “not valid entry”. The user then needs to re click the icon at 112.

Otherwise the program proceeds to 122, which is intended to provide the level of comfort to the user that the program running on his phone has not been hijacked by another piece of software and is masquerading as the software organizer of the present invention. To this end, the actual software displays on the system either the photo that has been previously inserted by the user, so the user sees him/herself and knows that the real program, and not a rogue software, is communicating with the user. Another alternative is to play the voice of the user or to show a unique photo; for example, of a horse or a bird or the like. If the user does not see the correct information, the user is alerted not to proceed.

Otherwise the software prompts the user to enter the master password at 124. Upon the entry of the master password (which is entered “incorrectly” in accordance with the personal conversion rule set up by the user, if desired), the program proceeds to 126 to authenticate the user by prompting the user to either speak a sentence or by taking a photo of the user and comparing it to the internally stored biometric information. Hence, a stranger who got a hold of the Master Password would still be unable to receive the individual passwords.

Once the user has been “authenticated” at 128, the program proceeds to display, for a short duration, the requested password 130 and prompts the user to either speak a word or to touch a screen icon at 132, whether the user wants to see another password. If so, the program proceeds to 134 and provides the second password, and so on. Note, each password is displayed for a short duration only, in a manner which does not allow snooping software (even if it has been somehow loaded on the user's computer) to actually copy or perceive the password.

Thereafter, the program proceeds to decisional box 136 and asks whether any of the passwords are to be changed and, if yes, the program proceeds to 138 to change the passwords in either an auto or manual fashion, as previously described. The program ends this procedure by turning on the radio communication (which has previously been turned off) at software module 115 in a manner similar to the previous description given relative to software modules 54 and 56. The program concludes at 142. Throughout the foregoing description of a preferred embodiment, the protected information was in the nature of passwords. But that information can be the contents of any file or record stored in the computer, indeed all the files in the given computer.

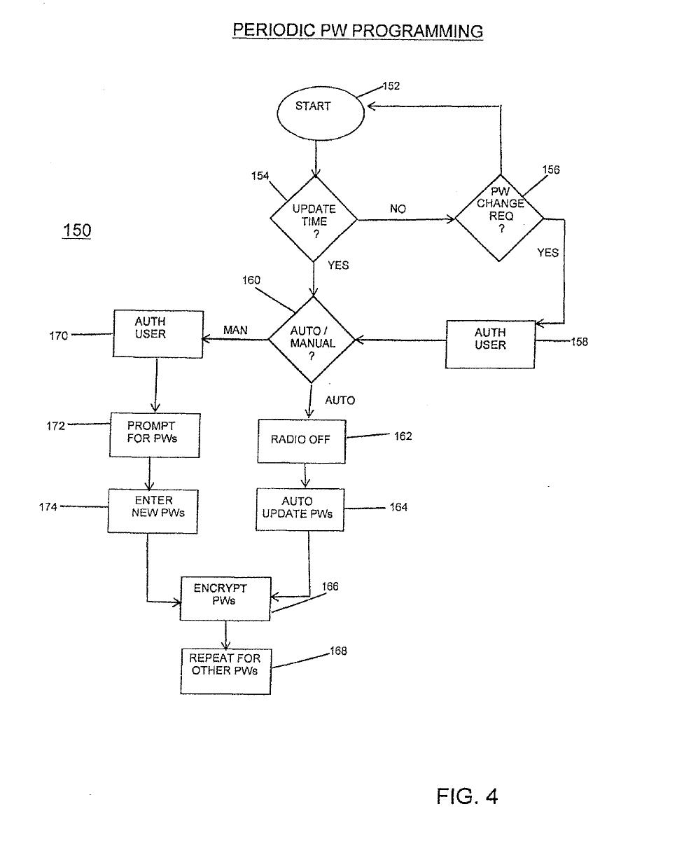

In accordance with other aspects of the invention, the internally stored passwords can be periodically, automatically updated as described below by reference to FIG. 4. For example, if the software has been preprogrammed to update/alter passwords every four months, then the operating program 150 begins with the start module 152 and thereafter proceeds to decisional box 154 querying whether it is presently the update time. If no, the software module 156 checks whether an operator has touched a given icon of the program and has, nonetheless, just requested to change a password and, if so, it “authenticates” the user as previously described at 158 and proceeds to decisional box 160. In decisional box 160, the program determines whether the software has been preset for automatic password changing or only manual. If automatic, the program turns the communication modem off at 162 and then changes all of the passwords at 164, and then encrypts and stores those modified softwares at 166. The process is repeated for all of the passwords at 168.

If, on the other hand, the user preset the program for only manual reprogramming, the user is authenticated as previously described at 170 and thereafter prompted for the new password at 172, which new passwords are entered and stored at 174 and thereafter encrypted at 166. As before, the process can be repeated for other passwords at 168.

In accordance with the foregoing description of the invention, one of ordinary skill in the art would appreciate that while a user sets up the program, or requests a certain password to be displayed, the radio or modem communication of the computer is totally shut off repeatedly, not allowing anyone to snoop on the software, as it is running, nor allowing a snooping software that has been somehow loaded on the user's computing device to report the keystrokes or other information to a remote location.

Such snooping rogue software is also prevented from storing the keystrokes or the display information in a local memory for later transmission to another computer, because the protected information is not displayed or entered in its precise format and any attempt to interfere with the authentic program would be noted by the user. For example, if the passwords are communicated by voice, the Trojan software would not be able at all to know what the password is, as software cannot “hear”. The user, on the other hand, can immediately either be reminded of the particular password and he/she may jot it down in whole or in part and immediately thereafter use it for whatever purpose they need to.

Turning to the second embodiment of the invention, its concept is to provide a special content region within a computer system 500 that cannot be accessed by anyone other than the owner/user of a particular computer while sitting and utilizing the local interface devices of the given computer, for example, its keyboard, display, printer, mouse and the like, physically connected to it or communicating with the computer by BlueTooth or local WiFi and the like.

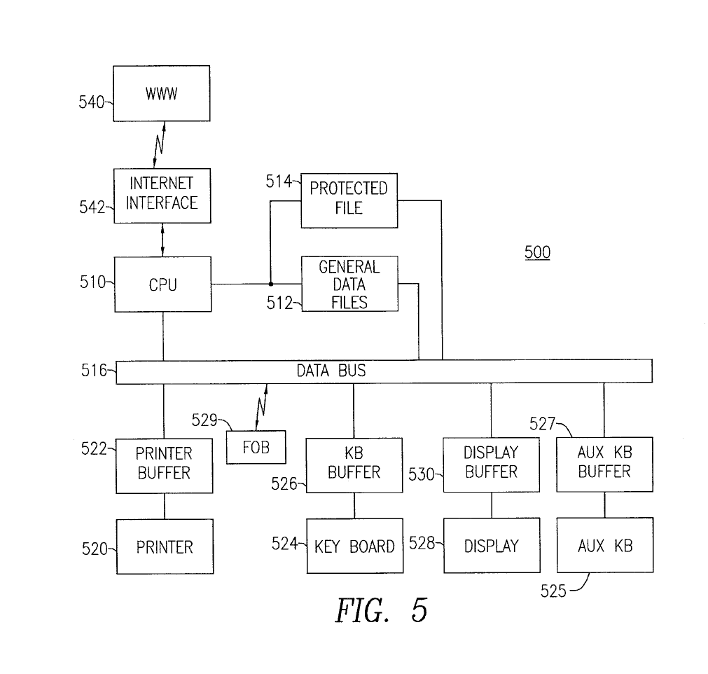

In FIG. 5, the computer system's CPU 510 is able to communicate, in the usual manner, with a standard memory 512 containing the general data files of the computer and also being able to communicate with the protected memory 514 containing the especially protected files. As typically found with computers, the CPU 510 can also communicate with many other hardware devices through a central data bus 516. In FIG. 5, communication to the printer 520 is established via the printer buffer 522. Similarly, the CPU 510 can communicate with the keyboard 524 by accessing the keyboard buffer 526 and with the display 528 by loading data into the display buffer 530. In accordance with a further embodiment, the system includes a special inputting device, e.g., an auxiliary keyboard 525, and a related buffer 527, dedicated for accessing confidential content.

Similarly, and as is well known, the CPU 510 has the hardware/software internet interface 542 to be able to communicate with the world wide web 540, either by wire or wirelessly, as well known.

Effectively, it is virtually impossible to protect data content in computers from being copied, altered, damaged and the like, either through hackers getting access to it through internet or by the implanting Trojan software into a person's computer and the like. The objective and implementation of the system of the present invention are designed to prevent that from happening.

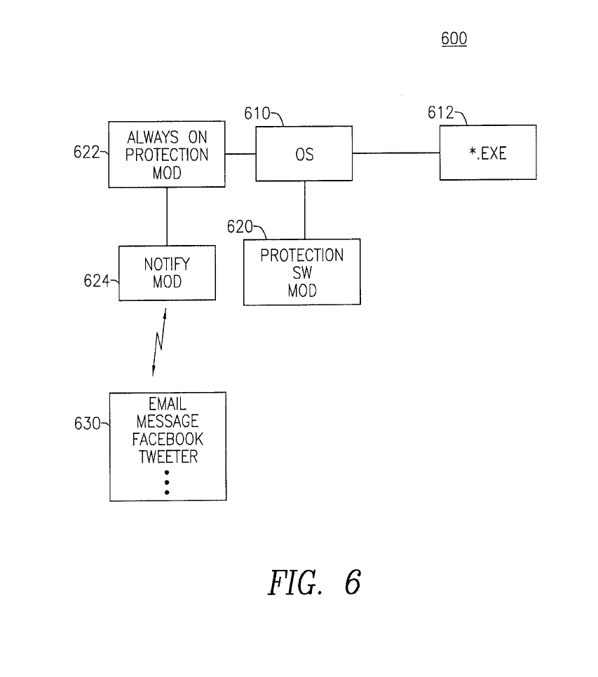

Turning to FIG. 6, and as well known, the CPU 510 is under the control of an operating system 610 which controls the overall operation including the executions of various execution files which are known as .exe files as indicated at 612.

However, the present invention provides a protection software module 620 that can be actuated manually by a user. When that software is launched, the CPU 510 operating under the operating system (and other software) immediately disables any and all data communications with the internet world 540. The protection software 620 also monitors and prevents any access to any of the printer or keyboard or display data buffers 522, 526, 530 while the protection software is enabled, except under the strict control of that software which is able to direct the CPU to either create information and store it in a protected file 514 or to access information from the protective file and to either display it on the display 528 or on the printer 520.

The protection software 620 is not merely a program that executes instructions. It also is software that monitors the entire data traffic on the data bus 516 to assure that no access to either the keyboard buffer 526 (or 527) or to the data bus is possible while that software 620 is active. In fact, that software has a priority level that does not allow any interfering software to become operational (except for software that is part of the operating system) and therefore is almost impossible for a hacker and the like to copy or send data in the memory 514, or in the keyboard buffer 526, etc., except if they have physical access to the physical computer.

With the present invention, a computer user can create highly confidential information while using the protective software 620, store that information in the protective file 514 and thereafter allow the internet functionality to be restored and the overall operation of the computer to be continued.

In addition to the protection software 620, the invention provides an “always-on” protection module 622 which is a software module associated with the protection objective of the present invention that is always running in the background within the computer and always monitors any attempt whatsoever to access the information in the protected file 514. Whenever the always-on protection software 622 detects even an attempt to access the data, it communicates to the software 610 to block that attempted access, and further communicate through the notify software module 624 to send a message to the computer user, based on a preset criteria whereby the information about the attempts to access that protected file 514 is communicated either via email, or messaging, or Facebook or Twitter (collectively 630) to inform the user about the attempted access and identify the software making that attempt.

In general, it is not necessary that the protected file 514 be a unique and unchangeable location within the computer memory, although that is possible. The protected file 514 can be located anywhere within the general memory of the computer, where the rest of the files are located.

In accordance with the further development of the present invention, the protection software 620 also provides an encryption facility that not only stores data within the protected file 514 but also encrypts it prior to such storage, and decrypts the contents when displayed to the user.

Thus, in accordance with the hardware system 500 and the accompanying software system 600 of the present invention, computer users can enjoy the advantage of having a special computer file or files within their computer system, e.g. desktop or laptop or tablet, etc., that is simply impenetrable to hackers whether they operate actively through the internet or via attempts to plant Trojan software within the computer system 500. Even if such a Trojan software module is installed, the always-on protection module 622 and its accompanying protection software 620 are also designed to always be on vigil and to not allow any other software, even to attempt to access the protected file except in accordance with the protocol of the software provided in the protection software module 620.

As is known, executory software files within computers are run based on prioritized systems and the present invention is such that its software will override all other software. Indeed, in accordance with the further embodiment of the present invention, the computer system will be provided with an operating system 610 that is located in unalterable memory, whereby it performs the functions of the always-on software 622 without allowing any later-added software to override its operation.

The embodiment of the invention described above relative to FIGS. 5 and 6 can obviously also be utilized for the purposes of storing passwords and the like inside the protected file area 514.

As described above, the present invention contains software and optionally special hardware that will stop any keystroke other than a manually entered keystroke from entering into the keyboard buffer of a computer, so as to defeat any attempt by Trojan software or software intruding through the internet from interfering with the protection of the protected computer file or files.

In functionality, the present invention provides a “safe”-like file that can hold any file data or passwords, and indeed almost the entire data contents of a personal computer. The file has been programmed to disable all internet access in or out from the PC/laptop/tablet/phone whenever anyone tries to access the contents of that safe-like file.

When a user needs to work on a file, he opens the safe-file which results in the internet being disabled, allowing the user to create secure data content or edit such content or print or view such content. When the user's work is completed, the user must manually reconnect the computer's internet functionality to enable the computer to re-connect to the internet to continue normal operation. Any time anyone tries to access the file from the outside, there will be an alarm message on the desktop with the intruder address and other information also being provided. This information can be the name of an executory file within the computer that has attempted to invade or access the protected file data. The system of the present invention is programmed so that launching the special software 600 requires a password. Therefore, if the PC is comprised/stolen, the contents of this unique, protective file cannot be taken as it will not be possible to access it in order to download it and to transmit it to the external world.

In a further embodiment of the invention, as a means of added protection against snooping on the contents of confidential records, the invention includes a FOB 529 which is either physically connected or wirelessly connected to the CPU 510 and which will allow either the keyboard 524 or the auxiliary keyboard 525 to be used for accessing the contents of confidential files 514 only if the FOB 529 is connected to or located in proximity to the CPU 510. Thereby, if a user has her/his computer actively connected and that user walks away from the computer while the FOB 529 is located in the pocket or on the body of the user, then the keyboard will be disabled entirely and coworkers of the users will not be able to access or even use the computer. Alternatively, in addition to the requirement that the contents of the protected file 514 be accessed via inputting devices 524, 525, the invention also may include that the user must go through a software routine and enter a special password to do so. In a further embodiment, the keyboard 525 (or even the conventional keyboard 524) may include a toggle switch thereon that needs to be physically toggled to one position in order to enable any writing or reading or displaying the contents of the protected file.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system for securely storing and recalling confidential contents in computer data records, protected from being hacked via the Internet and Trojan software, the system comprising:
a computer including confidential data handling software configured to enable a user to store in and retrieve from said computer said confidential contents solely via a local user inputting device;
communication hardware and software configured to enable the computer to communicate with other computers over public communication lines;
a software facility for turning off said communication hardware while the user is engaged in active utilization of said confidential data handling software; and
a software facility for blocking attempts to access said confidential contents by means that do not use said local user inputting device.

2. The system of claim 1, wherein the confidential data handling software is configured to store biometric information of at least one authorized user.

3. The system of claim 2, wherein the system includes authenticating software for authenticating a user based on said stored biometric information associated with the user.

4. The system of claim 1, including software for authenticating the software handling software to the user by displaying or playing to the user at least one of alpha-numeric information, visual information and/or vocal information recognizable by the user.

5. The system of claim 1, wherein said confidential contents are stored only in pre-defined, locally provided memory locations of said computer.

6. The system of claim 1, including a facility for encrypting said confidential content inputted into said computer.

7. The system of claim 1, including a software facility configured to store and display said confidential content based on personal encryption rules selected by and entered into the computer by the user.

8. The system of claim 1, including authenticating software configured to authenticate a user by requiring the user to enter a password that is unique to that user, said authenticating software being configured and serving only for the purpose of initiating operation of the confidential content handling software.

9. The system of claim 1, wherein the confidential data handling software includes a facility that enables retrieving one or more passwords by inputting into the computer a single, master password.

10. The system of claim 1, wherein said memory locations are located at a fixed, non-virtual range of memory addresses within said computer.

11. The system of claim 1, wherein said local user inputting device comprises a special keyboard connected to a computer with an external connector and said keyboard is used exclusively in conjunction with said password handling software.

12. The system of claim 1, wherein said confidential data handling software is configured to prevent storage in a keyboard buffer of said computer any keystrokes other than keystrokes that are entered by a human manually.

13. A method for securely storing confidential contents and recalling any of the stored confidential contents using a local inputting device, the method comprising:
providing a computer including confidential data handling software configured to enable a user to store in and retrieve from said computer said confidential contents exclusively via said local inputting device, said computer further including communication hardware configured to enable the computer to communicate with other computers over public communications lines;
operating the confidential data handling software to retrieve one or more of said confidential contents by using said inputting device; and
turning off said communication hardware while a user is engaged in active utilization of said password handling software via said user interface.

14. The method of claim 13, wherein the confidential data handling software is configured to store biometric information of at least one authorized user.

15. The method of claim 13, wherein the method includes authenticating a user based on previously stored biometric information associated with the user.

16. The method of claim 13, wherein the method includes authenticating the software to the user by displaying or playing to the user at least one of alpha-numeric information, visual information and/or vocal information recognizable by the user.

17. The method of claim 1, including encrypting said confidential contents and storing only encrypted confidential contents in said computer.

18. The method of claim 1, including storing and displaying said confidential contents based on personal encryption rules entered by the user.

19. The method of claim 13, including displaying to a user information unique to that user that has been previously selected by the user to be displayed to the user when communicating with the confidential data handling software.

20. The method of claim 13, including authenticating a user by requiring a user to enter a password that is unique to that user, which serves only for the purpose of initiating operation of the confidential data handling software.
